(19) United States
(12) Patent Application Publication
(10) Pub. No.: US 2013/0046459 A1
(43) Pub. Date: Feb. 21, 2013

(54) FLIGHT STATE CONTROL DEVICE OF FLYING OBJECT

(71) Applicant: Eiji Itakura, Susono-shi (JP)

(72) Inventor: Eiji Itakura, Susono-shi (JP)

(21) Appl. No.: 13/147,599

(22) PCT Filed: Apr. 22, 2010
(86) PCT No.: PCT/JP10/57154

§ 371 Date: Aug. 3, 2011

(51) Int. Cl. G08G 5/04

(52) U.S. Cl. 701/301

(57) ABSTRACT

Prediction means predicts a collision risk of a flying object with at least an altitude, a flying speed, and an attitude as parameters. When the prediction means determines that the collision risk is high, flight state control means controls the flying speed, the attitude, and a flying path to control the flight state of the flying object. Therefore, when the collision risk is high, it is possible to control the maneuvering of the flying object to prevent collision and to reduce impact at the time of collision.

### TECHNICAL FIELD

The present invention relates to a flight state control device of a flying object, and in particular, to a control device which predicts a collision risk of a flying object to control the flight state of the flying object.

### BACKGROUND ART

In recent years, a system has been developed which predicts a collision risk for a vehicle and performs control, such as collision avoidance or impact reduction at the time of collision. In a flying object, such as an aircraft, as a flight safety technique, a technique described in Patent Literature 1 is known. According to this technique, a dangerous region in such as inclement weather is determined, and a flight route is set to avoid the dangerous region vertically.

### CITATION LIST

### Patent Literature

[Patent Literature 1] PCT Japanese Translation Patent Publication No. 2000-515088A

### SUMMARY OF INVENTION

### Technical Problem

The invention described in Patent Literature 1 is primarily intended to determine a region to be avoided at the time of flight from weather conditions and to set a route which bypasses the region. According to this technique, however, it is not assumed that control is performed in accordance with the flight state of the flying object itself, and the possible application is limited to a small range.

Accordingly, it is an object of the invention is to provide a control device which predicts a collision risk for a flying object to controls the flight state of the flying object.

### Solution to Problem

In order to solve the above-described problem, a flight state control device of a flying object according to the invention includes prediction means for predicting a collision risk for the flying object with at least an altitude, a flying speed, and an attitude as parameters, and flight state control means for, when the prediction means determines that the collision risk is high, controlling the flying speed, the attitude, and a flight path to control the flight state of the flying object.

The prediction means may have first calculation means for calculating the aerodynamic control state of the flying object on the basis of the attitude in triaxial directions and the flying speed in the triaxial directions. The prediction means may have second calculation means for calculating the control state of the flying object on the basis of a maneuvering envelope.

The prediction means may have both the first and second calculation means, may predict the collision risk on the basis of the calculation results of the first calculation means and the second calculation means, and when it is determined that the collision risk is high, may further redetermine the flight state of the flying object on the basis of the calculation results of the first calculation means and the second calculation means after a predetermined time elapses.

### Advantageous Effects of Invention

According to the invention, the altitude, flying speed, and attitude of the flying object itself are used as parameters, thereby predicting a collision risk for the flying object on the basis of the current flight situation of the flying object with high precision. The flight state of the airframe is controlled on the basis of the prediction result, thereby appropriately performing collision avoidance control and pre-crash control.

According to the first calculation means or the second calculation means, it is possible to appropriately recognize the aerodynamic control state of the flying object, thereby improving the collision risk determination precision for the flying object.

With both the first and second calculation means, the aerodynamic control state of the flying object is recognized, and when risk is high, the control state after a predetermined time is further recognized. Therefore, it is possible to appropriately determine whether a dangerous state is continuing or recovered, thereby controlling the flying object based on changes in the flight state.

### BRIEF DESCRIPTION OF DRAWINGS

FIG. 1 is a block diagram showing the configuration of a flight state control device according to the invention;

FIG. 2 is a diagram showing an aerodynamic control state based on an altitude, a speed, and an attitude;

FIG. 3 is a graph illustrating adjustment of an altitude and an airframe speed at the time of control based on the device of FIG. 1;

FIG. 4 is a diagram illustrating a coordinate system which represents an attitude and a flying speed;

FIG. 5 is a diagram showing a stable range of an attitude and a flying speed; and

FIG. 6 shows an example of a maneuvering envelope.

### DESCRIPTION OF EMBODIMENTS

Hereinafter, a preferred embodiment of the invention will be described in detail with reference to the accompanying drawings. For ease of understanding of the description, the same constituent elements in the drawings are represented by the same reference numerals wherever possible, and overlapping description will be omitted.

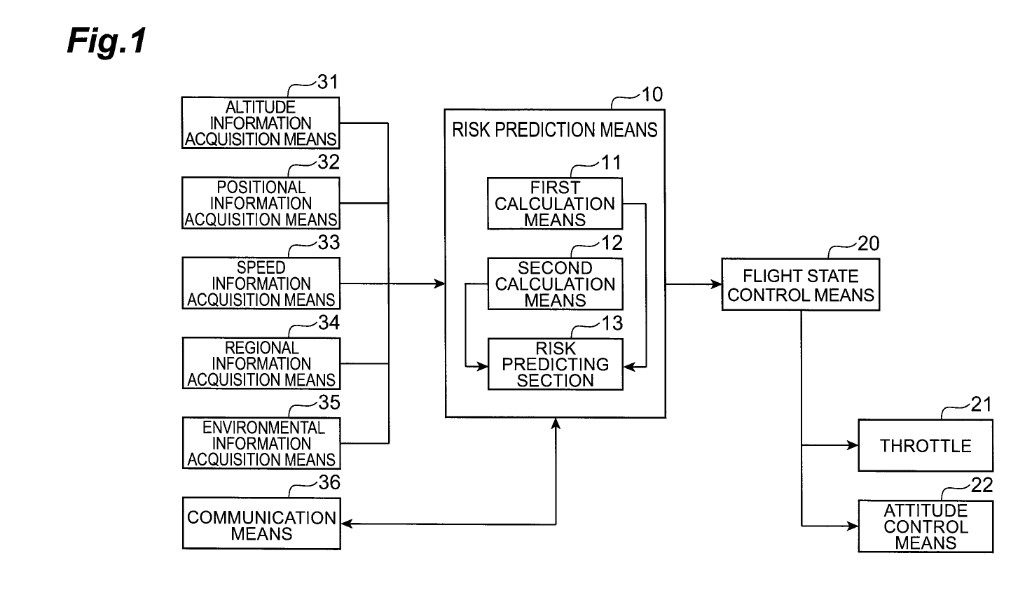

FIG. 1 is a block diagram showing the configuration of a flight state control device according to the invention. Although an example will be described where a flying object is a fixed-wing aircraft, the invention can be suitably applied to other types of flying objects. The flight state control device mainly includes flight state control means 20 for controlling the behavior of the airframe, and risk prediction means 10 for predicting a collision risk for the aircraft.

The risk prediction means 10 includes first calculation means 11 and second calculation means 12 serving as calculation means for calculating the aerodynamic control state of the airframe. The first calculation means 11 performs calculation with at least an altitude, a speed, and an attitude as parameters. Meanwhile, the second calculation means 12 performs calculation on the basis of a maneuvering envelope. Risk predicting section 13 determines a collision risk on the basis of the calculation results of the calculation means 11 and 12.

The outputs of altitude information acquisition means 31 for acquiring the altitude of the airframe, positional information acquisition means 32 for acquiring spatial positional information of the airframe, speed information acquisition means 33 for acquiring airframe speed information, regional information acquisition means 34 for acquiring information region a region where the aircraft is flying, and environmental information acquisition means 35 for acquiring ambient information are input to the risk prediction means 10. The risk prediction means 10 is connected to communication means 36 to transmit and receive information with respect to another aircraft, air-traffic facilities on the ground, or the like. The risk prediction means 10 outputs the prediction result to the flight state control means 20.

For the altitude information acquisition means 31, a barometric altimeter, a radio altimeter, or the like can be used. For the positional information acquisition means 32, an autonomous navigation device, a GPS (Global Positioning System) receiver, a radio navigation device, or the like can be used. For the speed information acquisition means 33, an airspeed indicator, a ground speed indicator, or the like can be used. For the regional information acquisition means 34, a navigation device which stores regional information in a storage device in the form of a database in association with positional information and reads regional information in accordance with positional information, a system which receives regional information by communication means, or the like can be used. The environmental information acquisition means 35 includes means for recognizing the atmospheric state in the vicinity of the aircraft, such as a barometer, a thermometer, or an airflow meter, means for acquiring the position and speed information of another aircraft, such as a radar or a communication device, and means for recognizing ambient weather conditions, a field of view, or the like.

The flight state control means 20 is connected to a throttle 21 and attitude control means 22 to control the activation of the throttle 21 and the attitude control means 22. Examples of the attitude control means 22 include a rudder, an elevator, an aileron, a high-lift device, and the like. The flight state control means 20 controls the activation of the throttle 21 of the engine or the attitude control means 22 in response to a hydraulic pressure signal or an electrical signal.

Risk determination in the risk predicting section 13 is performed by the following method. The current flight state is determined with the altitude, the flying speed, and the attitude as main parameters and a flight stage, a location, airflow, airframe performance, a pilot state, an airframe state, an engine state, and the like as sub parameters, and is classified into regions described below. An aerodynamic control state including an attitude may be obtained by the first calculation means 11 and second calculation means 12, and determination in the risk predicting section 13 may be performed with the aerodynamic control state as a parameter.

The flight stage represents a takeoff, cruising, or landing stage. The location is information regarding a runway within an accessible range from a current position, an obstacle, such as a building, a road state, or the like. The pilot state represents the skill, awareness level, or the like of a pilot. The airframe state and the engine state include the presence or absence of faults and the state thereof.

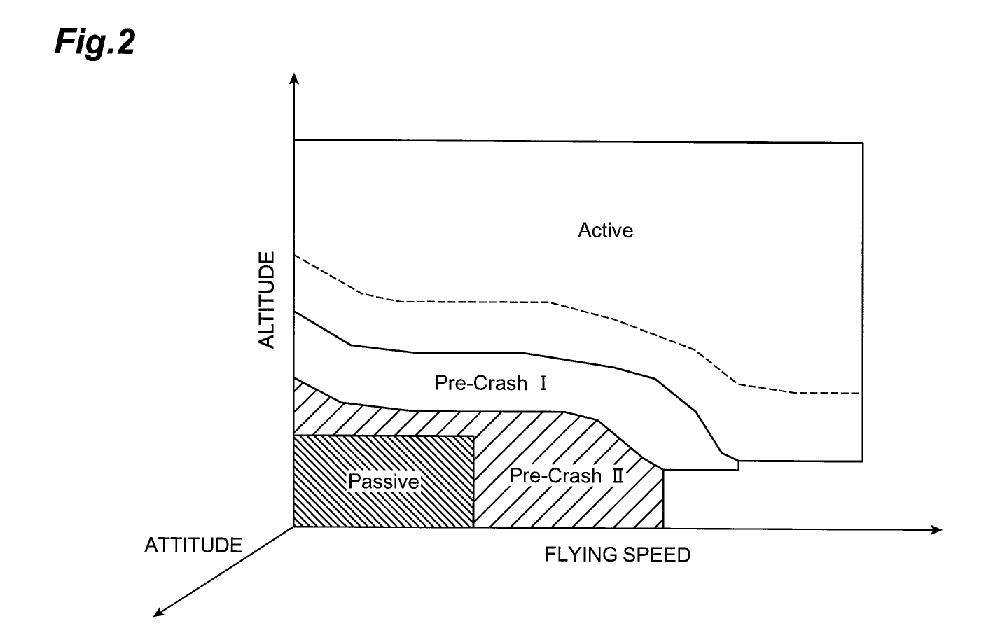

In this embodiment, the risk predicting section 13 mainly classifies the flight state into an Active region, a Pre-Crash region, and a Passive region. FIG. 2 is a determination diagram of the regions. In this case, the Pre-Crash region is further divided into two regions of a Pre-Crash I region and a Pre-Crash II region. Although in the drawing, a low-altitude and high-flying-speed region is unclassified, this region is excluded as a region which is not used at the time of normal flight, such as acrobatic flight.

The Active region is a region where a flight state is reached such that the aircraft can safely land on the runway. By comparing an upper region and lower region from a dotted line of the drawing, the upper region is a region where the behavior of the airframe is stable, and the lower region is a region where the behavior of the airframe is unstable but the transition to the upper region can be performed with a change in the attitude or the like.

Both two Pre-Crash regions and the Passive region are regions where the collision risk (the collision risk used herein indicates the possibility of collision) is higher than other regions. Of these, as shown in FIG. 2, the Passive region is set as a low-altitude and low-flying-speed region, and includes a flight state in which impact is absorbed by the airframe or the like at the time of collision to protect passengers. The Pre-Crash region is a region which is sandwiched between the Active region and the Passive region, and in which there is a need for the flight state control means 20 to transit the flight state to the Passive region.

In the Pre-Crash region, the Pre-Crash I region is a region where the transition to the Passive region can be performed through main control surfaces. The Pre-Crash II region is a region in the Pre-Crash region where the transition to the Passive region is not easily performed only with main control surfaces, and other kinds of airframe control, for example, the adjustment of thrust force, the actuation of the high-lift device, or the like, should be performed for the transition to the Passive region. Although in FIG. 2, the attitude parameter represents the same plane (altitude-flying speed plane), and the Pre-Crash II region is present between the Pre-Crash I region and the Passive region, when a coordinate system with altitude, speed, and attitude set with respect to the respective axes is used, there is a portion where the Pre-Crash I region and the Passive region are adjacent to each other, and the transition from the Pre-Crash I region to the Passive region through airframe control is performed through the adjacent plane.

The risk predicting section 13 notifies the flight state control means 20 of necessary airframe control on the basis of the classification result. The flight state control means 20 controls the throttle 21 and the attitude control means 22 to control the attitude, speed, and altitude of the aircraft.

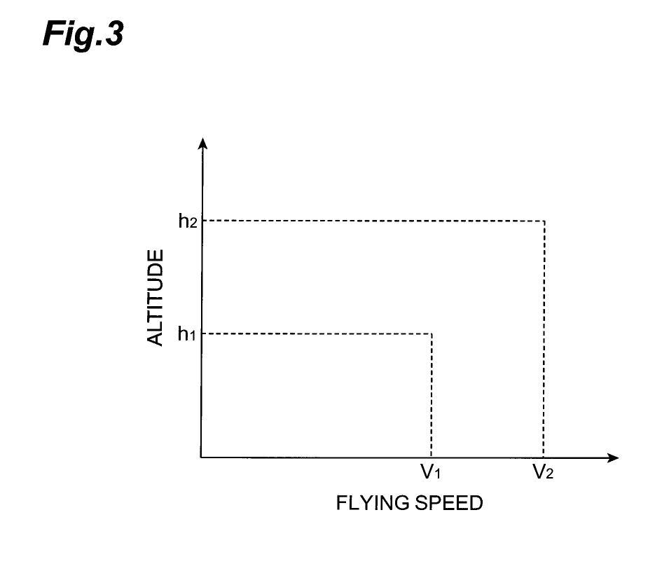

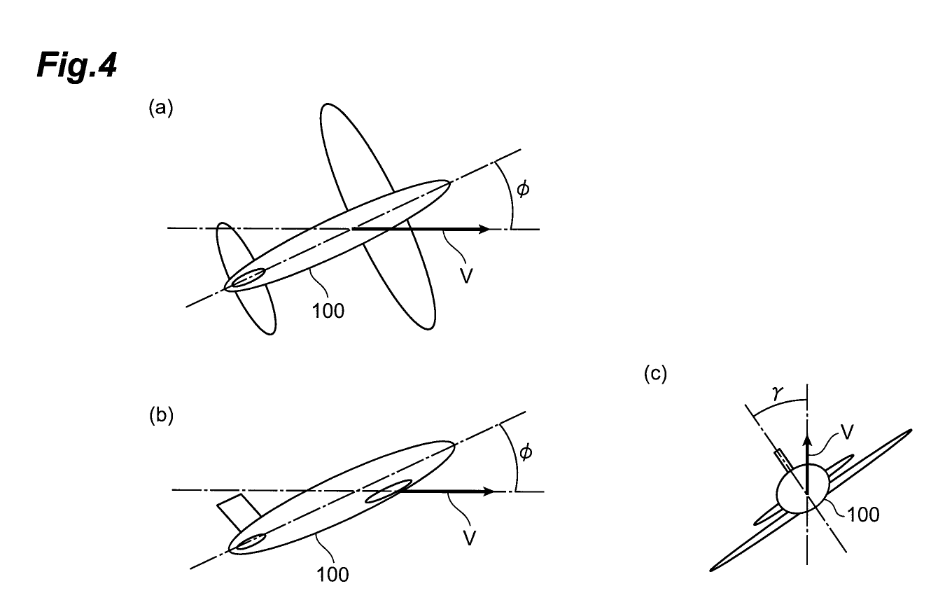

As the control method, there are (1) a decrease in the flying speed, (2) the adjustment of the attitude, and (3) the movement to a position where collision impact is lower. An example of (1) a decrease in the flying speed is shown in FIG. 3. In this case, as the flying speed decreases from V₂ to V₁, the altitude is lowered from h₂ to h₁. With regard to the attitude of (2), as shown in FIG. 4, the angles between the tri-axial directions of the attitude and the tri-axial directions of the airframe speed direction are respectively θ, φ, and γ, and the attitude may be expressed by these angles.

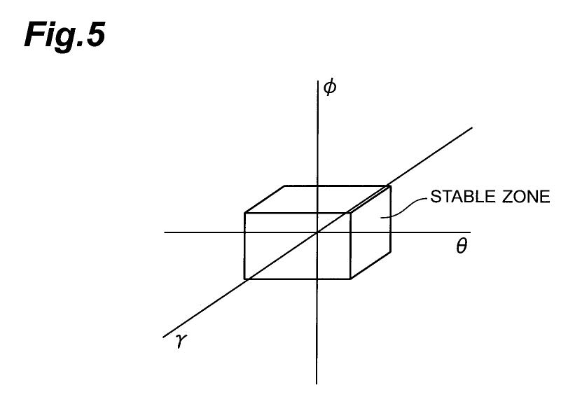

The first calculation means 11 recognizes the aerodynamic control state of the airframe on the basis of the positions in the coordinate system shown in FIG. 5 of the attitude parameters expressed in the above-described manner. A stable region shown in the drawing is a state where the aerodynamic control state is maintained, and is set in advance on the basis of a wind-tunnel experiment, calculation, an actual test, or the like. When outside the stable region, it may be determined that a state out of normal control is reached.

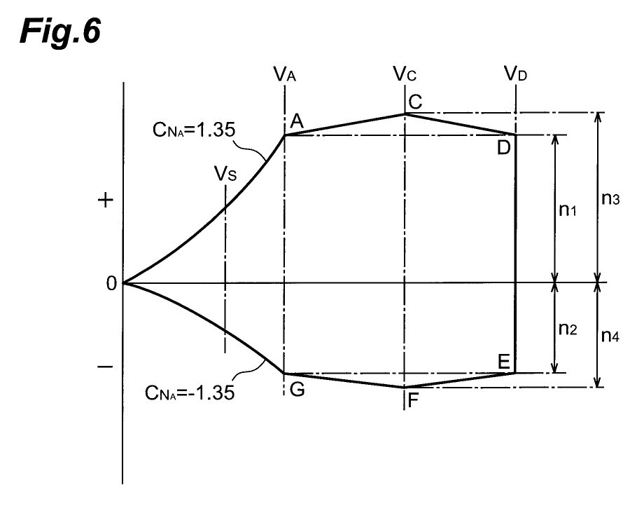

The second calculation means 12 recognizes the aerodynamic control state of the airframe on the basis of a maneuvering envelope. FIG. 6 shows an example of a maneuvering envelope. In the drawing, the horizontal axis represents an airframe speed, and the vertical axis represents a load factor (G). V_{A}, V_{C}, V_{D}, and V_{S} respectively represent a design maneuvering speed, a design cruising speed, a design diving speed, and a stalling speed. When outside the envelope, it is determined that a state out of normal control is reached.

The aircraft can recover the normal state on the basis of potential energy or speed energy of the airframe even when the aerodynamic control state is temporarily out of normal control (for example, returns from a stalling state). Accordingly, when a sufficient time width Δt is provided, if the aerodynamic control state is out of normal control at the time t, and the out-of-control state is identical or expanded at the time t+Δt, it is determined to be unrecoverable. Therefore, it is possible to determine whether or not the aerodynamic control state of the airframe is recoverable with satisfactory precision.

With regard to the region determination in the risk predicting section 13, similarly, determination is performed on the basis of a temporal change. Thus, even when the Pre-Crash region is temporarily entered, control for the transition to the Passive region is performed only when the recovery to the Active region cannot be performed. Therefore, it is possible to suppress the transition to the Passive region unintended by the pilot. Although an example has been described where the flight state is classified into four regions, determination may be performed with indexes which represent risk in numerical values.

### REFERENCE SIGNS LIST

10: risk prediction means, 11: first calculation means, 12: second calculation means, 13: risk predicting section, 20: flight state control means, 21: throttle, 22: attitude control means, 31: altitude information acquisition means, 32: positional information acquisition means, 33: speed information acquisition means, 34: regional information acquisition means, 35: environmental information acquisition means, 36: communication means.

1.-4. (canceled)

5. A flight state control device comprising:
first calculation means for calculating an aerodynamic control state of a flying object on the basis of an attitude in triaxial directions and a flying speed in the triaxial directions;
second calculation means for calculating the control state of the flying object on the basis of a maneuvering envelope;
prediction means for predicting collision risk on the basis of the calculation results of the first calculation means and the second calculation means, and when it is determined that collision risk is high, for further redetermining the flight state of the flying object on the basis of the calculation results of the first calculation means and the second calculation means after a predetermined time elapses; and
flight state control means for, when the prediction means determines that collision risk is high, controlling a flying speed, an attitude, and a flight path to control the flight state of the flying object.

6. The flight state control device according to claim 5,
wherein the prediction means performs the determination of collision risk in a current flight state with an altitude, a flying speed, and an attitude as main parameter and at least one of a flight stage, a location, airflow, airframe performance, a pilot state, an airframe state, and an engine state as sub parameters.

7. The flight state control device according to claim 5,
wherein the prediction means determines whether the current flight state corresponds to a state where safe landing is possible or a state where collision risk is high to perform prediction of collision risk.

8. The flight state control device according to claim 6,
wherein the prediction means determines whether the current flight state corresponds to a state where safe landing is possible or a state where collision risk is high to perform prediction of collision risk.

9. The flight state control device according to claim 7,
wherein the prediction means performs prediction while classifying into the state where collision risk is high, the state where passenger protection is possible with impact absorption at the time of collision, and another state.

10. The flight state control device according to claim 9,
wherein the prediction means performs prediction while further classifying another state in accordance with airframe control capable of being transited to the state where passenger protection is possible.

11. The flight state control device according to claim 10,
wherein airframe control is performed on the basis of the classification of airframe control capable of being transited to the state where passenger protection is possible classified by the prediction means.
